(19) United States
(12) Patent Application Publication
(10) Pub. No.: US 2007/0033117 A1
(43) Pub. Date: Feb. 8, 2007

(54) User interface and data acquisition for tax-return preparation

(76) Inventor: David K. Murray, Carlsbad, CA (US)

Correspondence Address: BLACK LOWE & GRAHAM, PLLC, 701 FIFTH AVENUE, SUITE 4800, SEATTLE, WA, 98104, US

(21) Appl. No.: 11/334,730

(22) Filed: Jan. 17, 2006

Related U.S. Application Data
(60) Provisional application No. 60/644,328, filed on Jan. 14, 2005.

(51) Int. Cl. G06F 17/22; G06F 3/00

(52) U.S. Cl. 705/31; 715/764

(57) ABSTRACT

A method of acquiring tax data to be used in preparing a tax return for a current tax-reporting period includes providing a graphical user interface displayable on a display device. In connection with at least one tax-data item associated with a prior tax-reporting period, the interface is operable to present to a user at least one displayable page soliciting user selection of the at least one item for updating. The at least one updated tax-data item is received from the user.

### PRIORITY CLAIM

The present application claims priority from U.S. Provisional Application No. 60/644,328 filed Jan. 14, 2005, which is, along with commonly owned and co-pending U.S. Patent Application No. Not Yet Assigned (Attorney Ref. No. TAXN-1-1002) entitled “USER INTERFACE FOR TAX-RETURN PREPARATION,” and commonly owned and co-pending U.S. Patent Application No. Not Yet Assigned (Attorney Ref. No. TAXN-1-1004) entitled “DISTRIBUTED TAX-RETURN-PREPARATION PROCESSING,” herein incorporated by reference.

### FIELD OF THE INVENTION

This invention relates generally to graphical user interfaces and, more specifically, to a user interface enabling a user to prepare a tax return.

### BACKGROUND OF THE INVENTION

Many of those who prepare tax returns are familiar with the myriad tax-return-preparation-software products currently available. Typically, these products enable a user to prepare a tax return by leading the user through a series of interview questions that solicit information necessary to prepare the return. For many users preparing a return in a given reporting period, a majority of the solicited information, such as, for example, user name, residential address and number of dependents, remains unchanged from the previous reporting period. Consequently, the user may be compelled to waste time entering data that he or she previously entered in preparing a tax return filed in a prior reporting period.

### SUMMARY OF THE INVENTION

In an embodiment of the invention, a method of acquiring tax data to be used in preparing a tax return for a current tax-reporting period includes providing a graphical user interface displayable on a display device. In connection with at least one tax-data item associated with a prior tax-reporting period, the interface is operable to present to a user at least one displayable page soliciting user selection of the at least one item for updating. The at least one updated tax-data item is received from the user.

This approach enables the user to forego re-entry of tax data describing user circumstances that have not changed from the prior reporting period.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a schematic view of a graphical user interface (GUI) according to an embodiment of the invention;

FIG. 4 is a schematic view of a portion of an interview according to an embodiment of the invention;

FIG. 5 is a schematic view of an additional portion of an interview according to an embodiment of the invention;

FIG. 6 is a schematic view of an additional portion of an interview according to an embodiment of the invention;

FIG. 7 is a flow diagram illustrating transition from the interview portion illustrated in FIG. 6 to an additional interview portion according to an embodiment of the invention; and

FIG. 8 is a flow diagram illustrating a method according to an embodiment of the invention.

### DETAILED DESCRIPTION OF THE PREFERRED EMBODIMENT

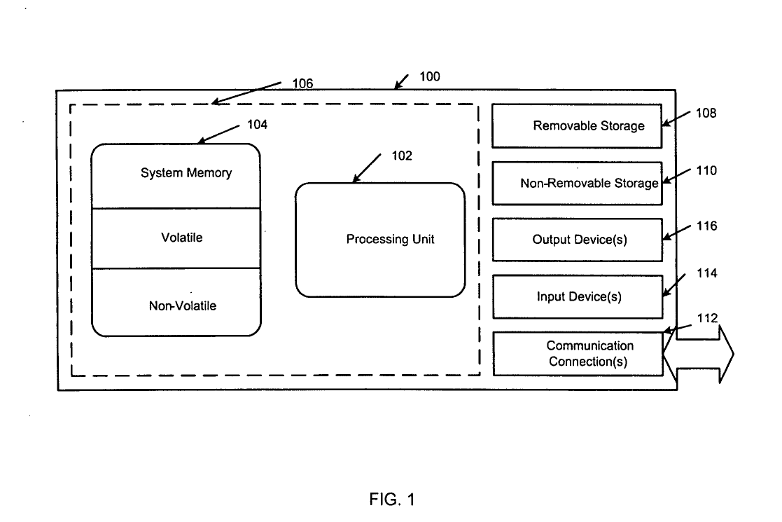

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to any one or combination of components illustrated in the exemplary operating environment 100.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed-computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 1, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. 1 by dashed line 106.

Additionally, device 100 may have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included. All such devices are well-known in the art and need not be discussed at length here.

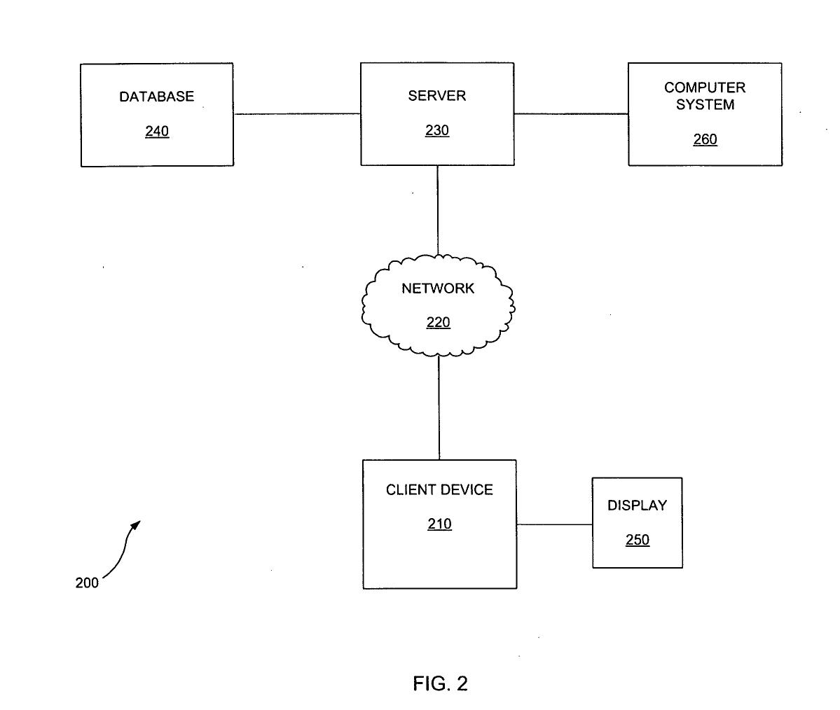

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the device 100 illustrated in and discussed with reference to FIG. 1. Client device 210 includes or is otherwise coupled to a computer screen or display 250. As is well known in the art, client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

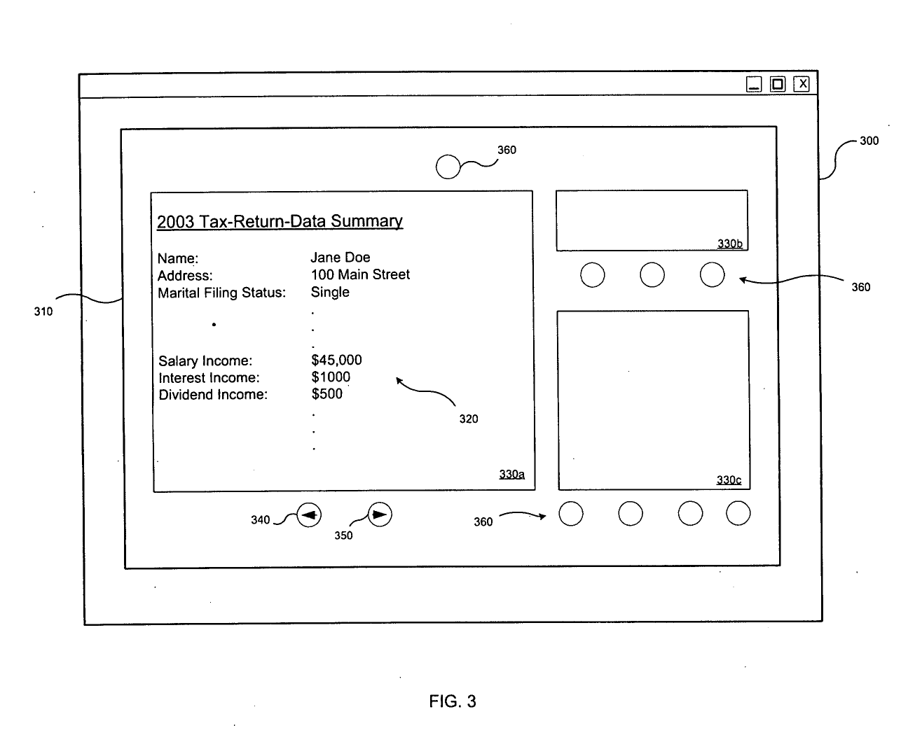

Still referring to FIG. 2, and in operation according to an embodiment of the invention, a user (not shown) of the client device 210 desiring to electronically prepare a tax return uses a browser application running on the client device to access web content served by the server 230. Specifically, and referring to FIG. 3, by employing an appropriate uniform resource locator (URL) in a known manner, the user may request a web page 300 to be displayed on the display device 250. Features and functionality of the web page 300 and associated user interface are described in commonly owned and co-pending U.S. patent application Ser. No. ______ (Attorney Ref. No. TAXN-1-1002) entitled “USER INTERFACE FOR TAX-RETURN PREPARATION,” which is, along with commonly owned and co-pending U.S. patent application Ser. No. ______ (Attorney Ref. No. TAXN-1-1004) entitled “DISTRIBUTED TAX-RETURN-PREPARATION PROCESSING,” herein incorporated by reference.

In an embodiment, and still referring to FIG. 3, the displayed web page 300 includes a user interface 310 having a plurality of panes 330a-330c within which information can be displayed and/or entered. Although the user interface 310 illustrated in FIG. 3 includes three panes 330a-330c, it is to be understood that embodiments of the invention described herein may be implemented in a user interface having more or fewer than three such panes.

In an embodiment, once the user has logged in, or otherwise identified himself to the server 230 in a conventional manner, the server retrieves from the database 240, or a memory device associated with the server, a set of tax data that was previously entered by or on behalf of the user and used to prepare a tax return for a prior reporting period. Alternatively, the server 230 and/or client device 210 may facilitate retrieval of this data from a memory device associated with the client device. Subsequently, at least a portion of this tax-data set is displayed as a summary 320 in one or more of the panes 330. In the illustrated example, the user is able to review in pane 330a the data that was used to prepare his tax return for the year 2003. By viewing the summary 320, the user may be better able to determine which tax-data item, if any, must be modified to describe the user's current circumstances in preparing a tax return for the current reporting period.

In the embodiment illustrated in FIG. 3, the summary is displayed in its entirety on a single page in a pane 330. Alternatively, the summary 320 may be separated into multiple portions that can be displayed in a pane 330 on multiple pages navigable by the user using a conventional “Previous” button 340 and “Next” button 350 provided in the user interface 310.

In an embodiment, one or more items (e.g., salary income, interest income, etc.) listed in the summary 320 may be selectable by the user. By selecting an item in the summary 320, the user may, for example, invoke display in one or more of the panes 330 of detailed information pertaining to the selected item. For example, by selecting the “Interest Income” item of the summary 320 illustrated in FIG. 3, the user may be able to view in pane 330c a list of assets from which the user derived interest income in the year 2003.

Once the user has reviewed the summary 320 of data associated with the tax return filed for the previous reporting period (e.g., year 2003), the user may commence compiling tax data to be used in preparing a tax return for the current reporting period (e.g., year 2004). The user may commence this process by selecting one or more buttons 360 provided in the user interface 310 to initiate a tax-data interview more fully described hereinafter and displayable in one or more of the panes 330. Alternatively, once the user initially invokes the web page 300, display of the summary 320 may be foregone in favor of immediately commencing the interview process.

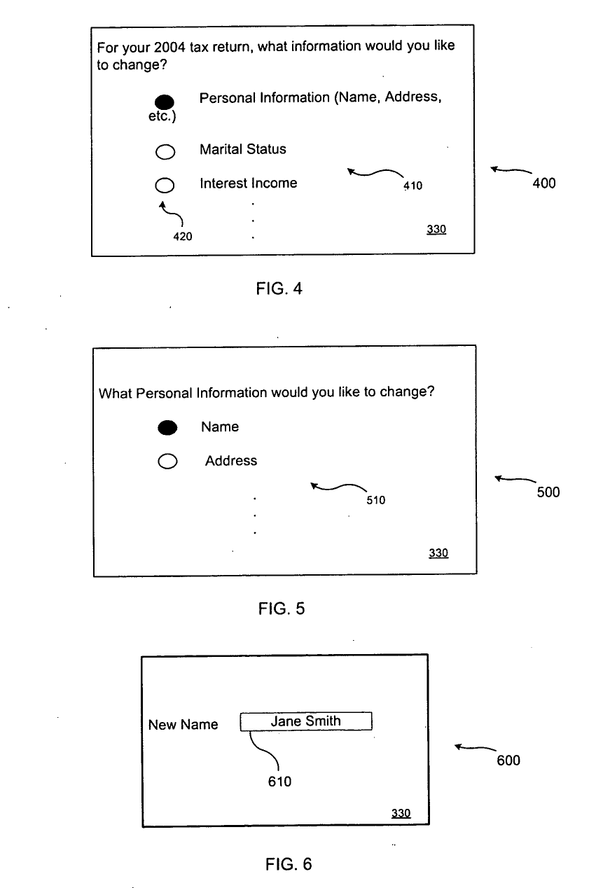

Referring to FIG. 4, upon commencing the interview process, a page 400 of the interview may be displayed in a pane 330 of the user interface 310. Advantageously, the page 400 solicits from the user one or more user selections of tax-data categories 410 corresponding to tax-data items that may be changed to accurately describe the user's current circumstances. In an embodiment, the interview process solicits from the user only tax-data items that have changed relative to a previous reporting period (i.e., the interview does not solicit entry by the user of data that has not changed since the previous reporting period). This approach enables the user to forego re-entry of tax data describing user circumstances that have not changed from the previous reporting period. The tax-data categories 410 may include personal information (e.g., name, address, etc.), information on dependents, marital-status information, W-2 (i.e., employment income) information, 1098/1099 interest-income information, and/or any other appropriate category indicative of information typically necessary to complete a tax return.

In an embodiment, and to better inform the user's selection of the tax-data categories 410 displayed on the page 400, the user may maintain or invoke display of one or more portions of the summary 320 in one or more of the panes 330 while viewing the interview page(s). Upon determining the tax data to be changed, the user may highlight a field, such as a radio button 420, corresponding to a category 410 that the user desires to select. Subsequently, the user may select one or more buttons 360 to submit the selected category. Alternatively, each category 410 may be displayed as a selectable hyperlink, the selection of which corresponds to submission of a selected category.

Referring to FIG. 5, in response to submission of the selected category 410, a subsequent page 500 may be displayed in one or more of the panes 330. In the example illustrated in FIG. 4, the user has selected “Personal Information” as the category 410 for which tax data is to be changed. Accordingly, the page 500 may solicit from the user one or more user selections of tax-data subcategories 510 appropriate to the selected category 410 and corresponding to the tax-data items to be changed. Subsequently, the user may submit the selected subcategory 510 in a manner described above.

Referring to FIG. 6, in response to submission of the selected subcategory 510, a subsequent page 600 may be displayed in one or more of the panes 330. In the example illustrated in FIG. 5, the user has selected “Name” as the subcategory 510 for which tax data is to be changed. Accordingly, the page 600 may provide a field, such as an alphanumeric-data-entry field 610 into which the user may enter her modified data (e.g., new name). Subsequently, the user may submit the modified data in a manner described above. In response to the submission of the modified data, the interview page 400 may be displayed to allow the user to modify further tax data in an above-described manner.

In an alternative embodiment, in response to submission of the selected category 410, and rather than displaying the page 500, the tax-data subcategories 510 may be displayed in the page 400. Additionally, in response to submission of the selected subcategory 510, the field 610 may likewise be displayed in the page 400.

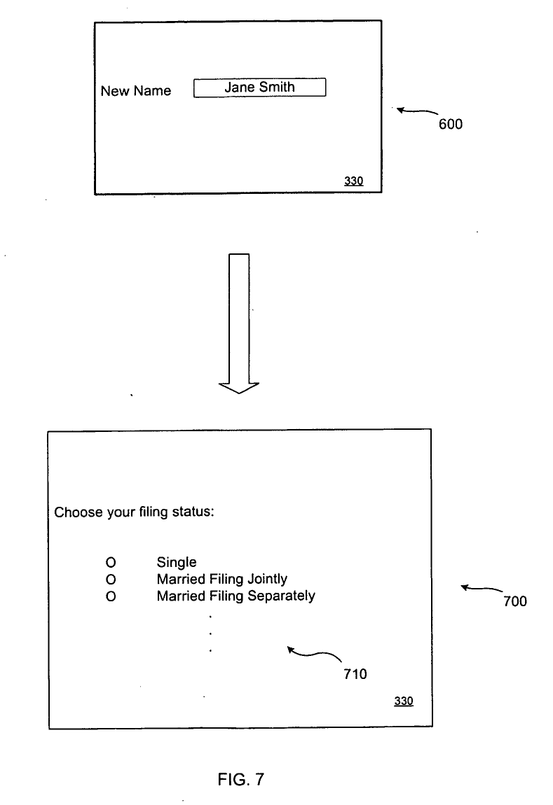

Referring back to FIG. 4, and in an alternative embodiment, the user is able to simultaneously select multiple categories 410 when viewing the page 400. For example, the user, because she has married and changed her name since the previous reporting period, may simultaneously select and submit the “Personal Information” and “Marital Status” categories 410 in a manner described above. Consequently, and referring to FIG. 7, in response to the submission of the modified name data discussed with reference to FIG. 6 (and, thus, successful modification of the “Personal Information” data), the pane 330 transitions from display of the page 600 directly to display of a page 700. In the illustrated example, the page 700 solicits from the user one or more user selections of tax-data subcategories 710 appropriate to the “Marital Status” category 410, thereby enabling corresponding tax-data items to be changed in an above-described manner. If the user selects and submits a third or more of the categories 410, then, upon successful modification of marital-status data, one or more pages allowing the user to modify further data may be presented to the user.

Upon submission by the user of a portion or the entirety of the modified data, the modified data may be provided by the client device 210 to the server 230. In an embodiment, the server 230 pre-populates an electronic tax-return form (not shown) with older tax data that, as described above, was previously entered by or on behalf of the user and used to prepare a tax return for a prior reporting period. Subsequently, the server 230 enters the modified data received from the client device 210 into the appropriate portion(s) of the electronic tax-return form. In an alternative embodiment, the server 230 first populates the electronic tax-return form with the modified data received from the client device 210 and subsequently populates the remainder of the tax-return form with the old tax data. Still alternatively, the server 230 retrieves the tax return filed for the prior reporting period and enters the modified data into the appropriate portions of this return to create a new tax return.

In an embodiment, the user may prompt, using, for example, one or more of the buttons 360, the user interface 310 to provide, in a manner similar to that described above, an interview soliciting from the user anticipated tax-data modifications that will apply to the ensuing reporting period. For example, if the user anticipates getting married in the coming year, the user may provide this information during the course of the interview. In turn, this information pertaining to the coming year may be stored by the client device 210 and/or the server 230 to pre-populate a tax return to be filed for the ensuing reporting period.

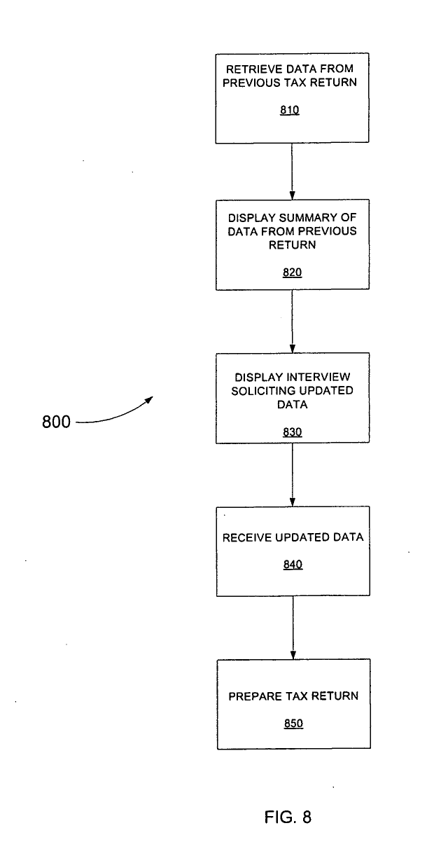

FIG. 8 illustrates a process 800 according to an embodiment of the invention. The process 800 is illustrated as a set of operations shown as discrete blocks. The process 800 may be implemented in any suitable hardware, software, firmware, or combination thereof. The order in which the operations are described is not to be necessarily construed as a limitation.

At a block 810, a set of tax data used to prepare a tax return for a prior reporting period is retrieved. For example, the server 230 may retrieve from the database 240, or a memory device associated with the server, a set of tax data that was previously entered by or on behalf of a user and used to prepare a tax return for a prior reporting period. Alternatively, the server 230 and/or client device 210 may facilitate retrieval of this data from a memory device associated with the client device.

At a block 820, a summary of data from the previous return is displayed to the user. For example, at least a portion of the tax-data set is displayed as a summary 320 in one or more of the panes 330. By viewing the summary 320, the user may be better able to determine which tax-data item, if any, must be modified to describe the user's current circumstances in preparing a tax return for the current reporting period.

At a block 830, a graphical user interface is displayed on a display device. The interface is operable to present to the user at least one page soliciting user selection of at least one tax-data item for updating, the non-updated at-least-one item being associated with a prior tax-reporting period. For example, the pages (e.g., pages 400, 500, 700) solicit from the user one or more user selections of tax-data categories (e.g., categories 410) and/or subcategories (e.g., subcategories 510, 710) corresponding to tax-data items that must be modified to accurately describe the user's current circumstances.

At a block 840, the updated tax data is received. For example, the client device 210 may provide the updated tax data to the server 230.

At a block 850, a tax return including the updated data is prepared. For example, upon receiving the tax data, the server 230 may be operable to prepare and electronically file a tax return including the updated data. Alternatively, the server 230 may provide tax data, including at least the updated tax data, to the computer system 260 by which, in turn, a tax return including the updated data is prepared and electronically filed.

While the preferred embodiment of the invention has been illustrated and described, as noted above, many changes and/or additions can be made without departing from the spirit and scope of the invention. For example, while the user interface 310 provided by the web page 300 has been primarily described herein as being served by the server 230 to the client device 210, all of the features and functions of the user interface could be implemented in an application executed completely or partially by the client device 210. Consequently, a tax return incorporating tax data, including data entered by the user via the user interface 310, may be prepared and filed by the client device 210. Accordingly, the scope of the invention is not limited by the disclosure of the preferred embodiment. Instead, the invention should be determined entirely by reference to the claims that follow. In one embodiment, a business method comprises providing one or more of the features and/or functions described above to users free of charge over the Internet. In another embodiment, the use of the system is provided for preparation of federal tax returns free of charge, and charges are only implied for non-federal (e.g. state returns). Alternatively, use for federal returns is charged, and for others is free of charge. Instead, the invention should be determined entirely by reference to the claims that follow.

The embodiments of the invention in which an exclusive property or privilege is claimed are defined as follows:

1. A method of acquiring tax data to be used in preparing a tax return for a current tax-reporting period, the method comprising:
providing a graphical user interface displayable on a display device, the interface operable to present to a user an interview soliciting user modification of at least one tax-data item associated with a prior tax-reporting period; and
receiving the at least one modified tax-data item from the user.

2. The method of claim 1 wherein the interview solicits from the user only modification of the at least one tax-data item.

3. A computer-readable medium having computer-executable instructions for performing steps to acquire tax data to be used in preparing a tax return for a current tax-reporting period, the steps comprising:
providing a graphical user interface displayable on a display device, the interface operable to present to a user at least one displayable page soliciting user selection of at least one tax-data item for updating, the non-updated at least one item being associated with a prior tax-reporting period; and
receiving the at least one updated tax-data item from the user.

4. The method of claim 1 wherein the interface is further operable to present to the user the unmodified at least one tax-data item associated with the prior tax-reporting period.

5. The method of claim 4, further comprising retrieving the unmodified at least one tax-data item over a network.

6. The method of claim 4 wherein, in response to user selection of the unmodified at least one tax-data item, the interface is further operable to present to the user information pertaining to the unmodified at least one tax-data item.

7. The method of claim 4 wherein the interface is further operable to simultaneously present on the display device the interview and unmodified at least one tax-data item.

8. The method of claim 1, further comprising:
pre-populating an electronic tax-return form with the unmodified at least one tax-data item associated with the prior tax-reporting period; and
populating the electronic tax-return form with the at least one modified tax-data item.

9. The method of claim 1 wherein the interface is further operable to solicit from the user an anticipated modification of at least one tax-data item associated with a future tax-reporting period.

10. The medium of claim 3 wherein the interface is further operable to present to the user the non-updated at least one item associated with the prior tax-reporting period.

11. The medium of claim 3 having further instructions for performing the step of retrieving the non-updated at least one item from a device executing the instructions.

12. The medium of claim 10 wherein, in response to user selection of the non-updated at least one item, the interface is further operable to present to the user information pertaining to the non-updated at least one item.

13. The medium of claim 10 wherein the interface is further operable to simultaneously present on the display device the displayable page and non-updated at least one item.

14. A system, comprising:
(a) a memory device; and
(b) a first electronic device coupled to the memory device and operable to:
(1) provide to a second electronic device a graphical user interface displayable on a display device, the interface operable to present to a user an interview soliciting user modification of at least one tax-data item associated with a prior tax-reporting period; and
(2) receive the at least one modified tax-data item from the user.

15. The system of claim 14 wherein the first electronic device is further operable to retrieve the unmodified at least one tax-data item from the second electronic device.
